(19) United States
(12) Patent Application Publication
(10) Pub. No.: US 2021/0192461 A1
(43) Pub. Date: Jun. 24, 2021

(54) MULTIPLE CALENDAR DISPLAY

(71) Applicant: Microsoft Technology Licensing, LLC, Redmond, WA (US)

(72) Inventors: Lawrence Waldman, Kirkland, WA (US); Sharvari Nerurkar, Redmond, WA (US)

(21) Appl. No.: 16/718,786

(22) Filed: Dec. 18, 2019

(51) Int. Cl. G06Q 10/10; G06F 16/27; G06F 3/0484

(52) U.S. Cl. CPC G06Q 10/1093; G06F 3/0482; G06F 3/04847; G06F 16/27

(57) ABSTRACT

Systems and methods may be used for selectively synchronizing data between calendars. These systems and methods may include receiving a user configuration of a calendar entry within a time slot in a primary calendar, identifying a secondary calendar associated with the primary calendar, and blocking off the time slot in the secondary calendar, based on a rule affecting fewer than all entries on the primary calendar, by generating a second calendar entry on the secondary calendar based on the user configuration of the calendar entry. In an example, in response to a user selection to display the secondary calendar, a method may include displaying the secondary calendar including the blocked off time slot.

### BACKGROUND

Electronically presented calendars include entries with information about events. The events may include locations, dates, times, participants, or other details. Some calendars provide scheduling options, such as appointments, meetings, video conferencing, telephony, or the like. An electronic calendar may be presented in a calendar user interface. A calendar user interface may be a stand-alone app or integrated into another app, such as a communications app.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B illustrate a calendar user interface including multiple calendars according to some examples of the present disclosure.

FIG. 2 illustrates a blocked time slot within a calendar on a calendar user interface according to some examples of the present disclosure.

FIG. 3 illustrates a calendar entry rule configuration user interface component of a calendar user interface according to some examples of the present disclosure.

FIG. 4 illustrates an agenda view of a calendar user interface according to some examples of the present disclosure.

FIG. 5 illustrates an example calendar user interface for configuring a rule according to some examples of the present disclosure.

FIG. 6 illustrates a flowchart of a technique for presenting a calendar user interface for user configuration of a calendar entry according to some examples of the present disclosure.

FIG. 7 illustrates a flowchart of a technique for presenting a calendar user interface including a primary calendar and one or more secondary calendars according to some examples of the present disclosure.

FIG. 8 illustrates a block diagram of an example machine which may implement one or more of the techniques discussed herein according to some examples of the present disclosure.

### DETAILED DESCRIPTION

Systems and methods for presenting a calendar user interface are described herein. The calendar user interface may display entries of a primary calendar. The primary calendar may be determined based on a current context, such as based on a user login, a current user attribute (e.g., selection, type of user, credentials, etc.), a time of day, an app context (e.g., based on a chat conversation or a video conference), a location (e.g., work, home, etc.), or the like. One or more secondary calendars may be associated with the primary calendar or the user. The one or more secondary calendars may be user selected or generated based on context information.

In an example, these systems and methods may be used to display a primary calendar and an associated secondary calendar in a minimized view or in an expanded view. The minimized view may include displaying one or more awareness indicators on a calendar user interface that is also displaying events of the primary calendar. The awareness indicators correspond to events on the secondary calendar. More than one secondary calendar may correspond to the primary calendar and respective awareness indicators may correspond to one or more of the secondary calendars. The awareness indicators may be small indicators of events that are displayed visually distinct from events of the primary calendar. In an example the awareness indicators may be expanded to include additional details not shown in the minimized view.

In an example, systems and methods described herein may be used to block of a time slot on a secondary calendar via an entry on a primary calendar. The time slot may be automatically blocked off on the secondary calendar when an entry is configured (e.g., generated or modified) on the primary calendar. In order to block off the time slot, an entry on the secondary calendar may be generated. The entry on the secondary calendar may have fewer details than the entry on the primary calendar (e.g., as little as the time or as much as leaving out a single detail, such as content of a meeting, or the like). The entry on the secondary calendar may be tied to the entry on the primary calendar (e.g., be conditional on the entry in the primary calendar). For example, when the entry on the primary calendar is changed, the entry on the secondary calendar may be automatically changed.

In an example, a user may configure a rule for blocking off time slots on one or more secondary calendars. For example, blocking off may occur only when certain conditions are met, such as a time of day, a type of entry, a user selection to block off the time slot occurs, a particular person is on a meeting invite, or the like. The blocking off may occur when a user selects an option block off the time slot (e.g., by long pressing or right clicking or the like) on the entry on the primary calendar.

The systems and methods described herein solve technical problems related to visualization and processing of multiple calendars for a user. One example technical solution described herein provides a user interface to display aspects of multiple calendars (e.g., an improvement in current calendar display technology that results in a technical effect of displaying awareness indicators of a second calendar in a primary calendar user interface). Another technical solution described herein provides a technique for sharing limited information from one calendar to another, for example by blocking off a time entry in a secondary calendar the time entry corresponding to a calendar entry in a primary calendar. The blocking off of the time entry provides a technical effect of preventing a user from entering a calendar entry on a secondary calendar that conflicts with an entry on a primary calendar (e.g., with a prompt). This example may provide a visual representation, on a secondary calendar user interface, of an entry of a primary calendar without sharing potentially sensitive details from the entry of the primary calendar.

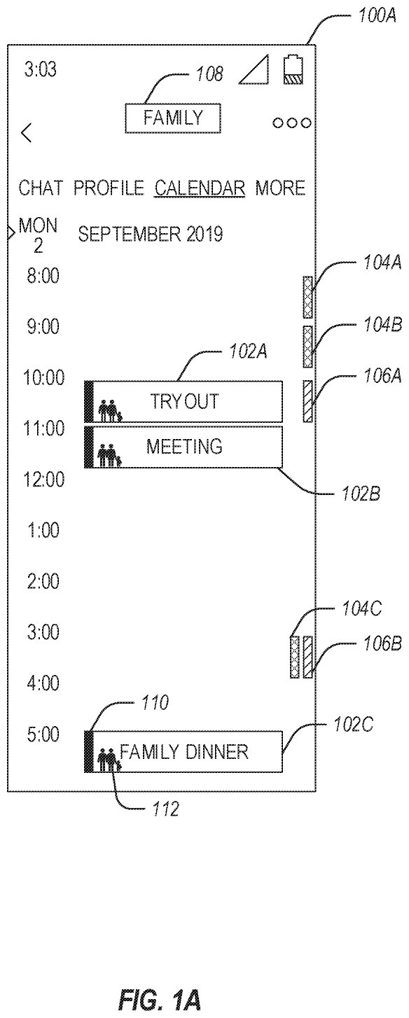

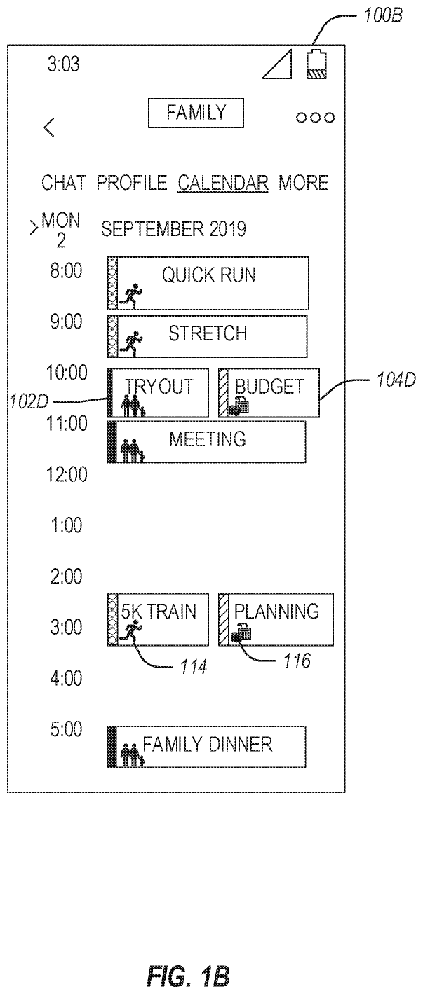

FIGS. 1A-1B illustrate a calendar user interface in a first state 100A and in a second state 100B including multiple calendars according to some examples of the present disclosure. The calendar user interface of FIG. 1A is configured to display entries (102A-C) of a first calendar and awareness indicators (es., 104A-C or 106A-B) for one or more secondary calendars. The displayed primary calendar may be determined based on a context, for example a profile, chat session, user selection, geolocation of the device, etc. An indication 108 of the context may be displayed in the calendar user interface 100.

The calendar user interface first state 100A of FIG. 1A includes a minimized view, so called because the awareness indicators (e.g., 104A-C and 106A-B) are minimized and shown without at least one relevant detail. For example, awareness indicator 104A is shown without text, but may include some details such as a time (8:00) for a corresponding calendar event. A corresponding calendar event may include a set of details that are shown when the full event is shown, a set of details that are shown when the event is shown as a part of a primary calendar, and a set of details that are shown when the event is shown using an awareness indicator as part of a secondary calendar. The sets of details may partially overlap, and in one example, each set described above may have fewer details shown for the awareness indicator than the primary calendar event, which itself may show fewer details than the full event.

In an example, awareness indicators corresponding to a particular secondary calendar (e.g., 104A-104C) may include a color or identifying mark signifying that the awareness indicators (e.g., 104A-C) all belong to that particular secondary calendar (shown in FIGS. 1A-1B as a crosshatch). Similarly, awareness indicators (e.g., 106A-106B) for another secondary calendar are shown with a different color or identifying mark (in FIGS. 1A-1B with stripes). The primary calendar entries (e.g., 102A-102C) may be shown with yet another color 110 or identifying mark 112.

In an example, the color 110 or the identifying mark 112 may be automatically generated or may be selectable or changeable by a user. For example, for the user context shown on the calendar user interface 100, an indication 108 appears as “family” indicating that the primary calendar shown is a family calendar. The identifying mark 112 is a family icon, which corresponds to the user context of “family.” Other examples are shown in FIG. 1B, such as a runner in indication 114, corresponding to a user context of an exercise secondary calendar, and an indication 116, corresponding to a user context of a budgeting/planning secondary calendar. For calendars that do not have a clear category of context, an arbitrary identifying mark may be used, such as an emoji.

The calendar user interface second state 100B of FIG. 1B includes an expanded view format for entries of the secondary calendar, which may be activated by a user input to switch from the minimized view. The expanded view format expands the awareness indicators to include additional scheduling information in a timeslot. In an example, the expanded view format of a corresponding awareness indicator may include the same types of information displayed in the display entries (102A-C) of the primary calendar. In another example, the additional scheduling information corresponding to an awareness indicator may display fewer or different types of information from the display entries (102A-C). In yet another example, when a display entry 102D is at a same time slot as an expanded view of a secondary calendar entry 104D, the display entry 102D may be modified (e.g., display less information or fewer types of information, or have a smaller icon space or dimension).

The expanded view may be specific to an awareness indicator (e.g., a single expanded view format is displayed while other awareness indicators are not expanded) or general to the calendar user interface 100A-100B (e.g., all awareness indicators are displayed in the expanded view format when accessed). The expanded view may be activated based on a user input (e.g., a gesture such as a swipe, a click, or the like).

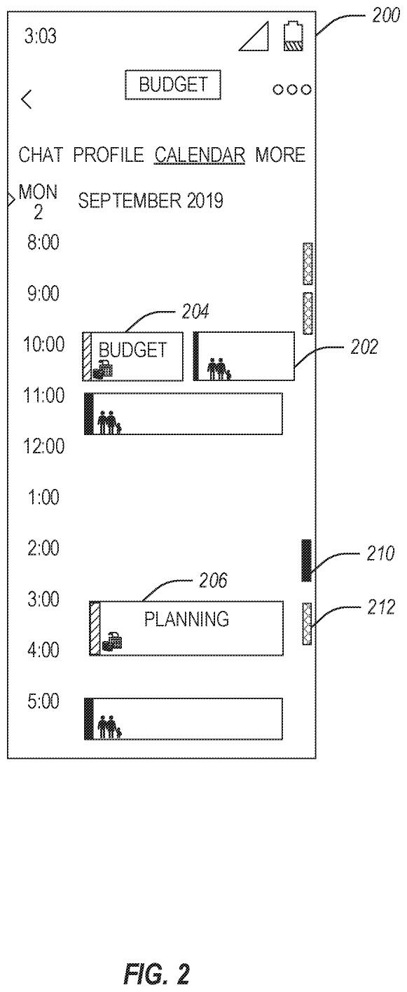

FIG. 2 illustrates a blocked time slot within a calendar on a calendar user interface 200 according to some examples of the present disclosure. The calendar user interface 200 shows a calendar with calendar entries blocking time slots, such as calendar entry 202. In an example, the calendar shown in the calendar user interface 200 is the secondary calendar referenced above with respect to FIGS. 1A-1B. The calendar shown in the calendar user interface 200 may be a new primary calendar (e.g., based on user context). The meaning of a secondary calendar may include any calendar that is not currently a primary calendar based on user context. For example, a calendar may be a secondary calendar when a different calendar is displayed, but becomes a primary calendar when displayed.

In other examples, a secondary calendar may be subordinate or dependent in some manner on a primary calendar. For example, a user may select a calendar to be a primary calendar and include one or more secondary calendars. A secondary calendar may be secondary based on a rule (which may be automatically implemented, user configured once for a calendar, or user selected on a case-by-case basis). The rule may include, for example, automatically blocking off time in a secondary calendar when a primary calendar entry is configured (e.g., generated, updated, saved, etc.). In another example, a secondary calendar may be secondary because of content, such as for public calendars, non-user controlled calendars, co-controlled calendars, or the like.

In the calendar user interface 200, the example calendar shown is a “budget” calendar. The budget calendar shows calendar entries including details, such as entries 204 (“budget”) and 206 (“planning). The calendar user interface 200 includes an example blocked off time slot, with a blocked off calendar entry 202. The blocked off calendar entry 202 in this example may correspond to the “tryout” calendar entry 102A or 102D of FIG. 1A or 1B. The blocked off calendar entry 202 may include fewer details or fewer types of details than a corresponding calendar entry from another calendar. As seen in the blocked off calendar entry 202, an icon representing the primary calendar (here, a family) may be shown to identify the corresponding calendar. In an example, blocked off calendar entries for more than one other calendar may appear in the calendar user interface 200. Icons may be used to differentiate which other calendar corresponds to a blocked off calendar entry.

In the example calendar user interface 200, an awareness indicator for another calendar may be displayed (e.g., in addition to calendar entries corresponding to a current user context or calendar, and blocked off calendar entries for one or more other calendars). A first awareness indicator 210 is shown corresponding to the family calendar (e.g., identifiable by color in this example, but may include an icon or other identifying feature). This example illustrates that not all entries for a calendar need be turned into blocked off calendar entries, but instead the blocked off calendar entries may be applied based on a rule. For example, a blocked off calendar entry may be generated for entries on another calendar within a time frame, based on a user selection in a case-by-case basis, for particular activities, based on a user device (e.g., always block off entries received from a computer, but do not automatically block off entries received from a mobile device), based on a method of generating the entry on the other calendar (e.g., if the entry is automatically added to the other calendar, such as via a meeting invite, do not block off time), or the like.

A second awareness indicator 212 is shown in the example calendar user interface 200 to illustrate an example where a third calendar has related entries for display. The second awareness indicator 212 may correspond to a calendar that is secondary to the current user context calendar displayed in the calendar user interface 200. The awareness indicators may be displayed in a minimized view or in an expanded view format as described above with respect to FIGS. 1A-1B.

The blocked off calendar entry 202 may be automatically generated for the secondary calendar (e.g., the budget calendar) based on generation of a calendar entry on a primary calendar (e.g., the family calendar). In an example, the blocked off calendar entry 202 is displayed on the calendar user interface 200 when the secondary calendar is selected for display (e.g., based on a current user context).

In an example, details related to the blocked off calendar entry 202 may be displayed when the blocked off calendar entry 202 is selected. For example, when the user has access to both calendars (e.g., has applicable credentials or read-access), the details may be viewed when the blocked off calendar entry 202 is selected.

In an example, details (e.g., additional scheduling information for a time slot) related to the blocked off calendar entry 202 or an awareness indicator may be cached locally on a device displaying the calendar user interface 200. When a secondary calendar (e.g., with the blocked off calendar entry 202 or corresponding to the awareness indicator 212) is selected for display, the local cache may supply the details for display on the secondary calendar as needed.

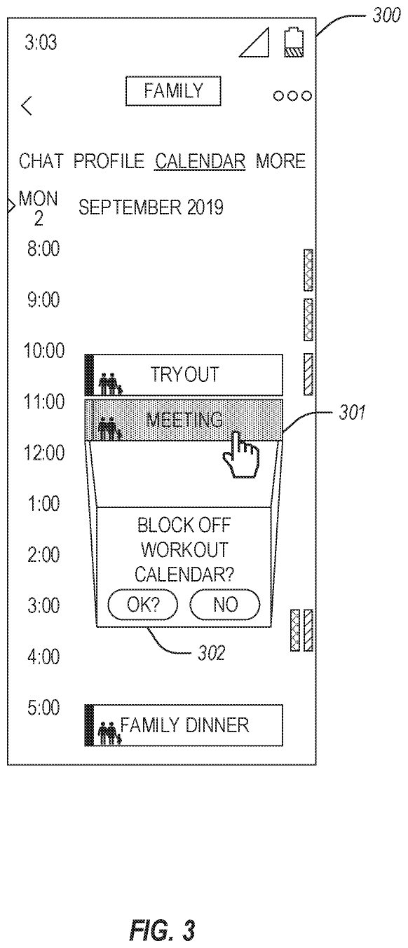

FIG. 3 illustrates a calendar entry rule configuration user interface component 302 of a calendar user interface 300 according to some examples of the present disclosure. The calendar user interface 300 shows a primary calendar with entries in an expanded view and awareness indicators for one or more secondary calendars. The calendar user interface 300 shows a user selection (e.g., a long press on a touchscreen, a right click using a mouse, etc.) of a calendar entry 301 for a “Meeting.” In response to the user selection, a calendar entry rule configuration user interface component 302 may be displayed. The component 302 may include a selectable option to block off a secondary calendar (e.g., a workout calendar, a family calendar, a work calendar, a school calendar, etc).

In an example, when the user selects the option to block off the secondary calendar, a corresponding calendar entry may be generated for the secondary calendar (e.g., the blocked off calendar entry 202 of FIG. 2). The corresponding calendar entry may include fewer details or fewer types of information than the calendar entry 301. In an example, the corresponding calendar entry may include information referencing the calendar entry 301, the primary calendar, a context, etc.

In another example, the calendar entry rule configuration user interface component 302 may pop up automatically when a calendar entry is generated within the calendar user interface 300 to confirm whether to block off a secondary calendar. More than one secondary calendar may be blocked off simultaneously using the calendar entry rule configuration user interface component 302, according to an example.

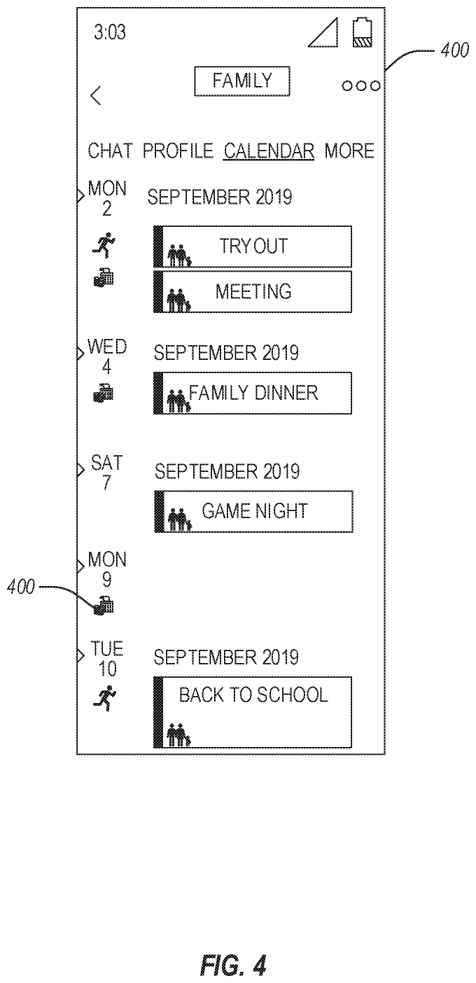

FIG. 4 illustrates an agenda view of a calendar user interface 400 according to some examples of the present disclosure. The agenda view may skip dates without entries. For example, the calendar user interface 400 displays September 2, 4, 7, 9, and 10, skipping the 3rd, 5th, 6th, and 8th, which do not have entries. In an example, the agenda view may include skipping any dates that do not have entries on a current or primary calendar. In another example, the agenda view include displaying a date that corresponds to an awareness indicator, even when the date does not include any calendar entries of the current or primary calendar.

The example shown in FIG. 4 includes a date without a primary calendar entry (September 9) because that date has a secondary calendar entry, which is indicated by icon 402. Selection of the icon 402 may show additional scheduling information related to a calendar entry of the secondary calendar corresponding to the icon 402. When more than one entry exists for a date in a secondary calendar, the icon 402 may be used to display expand views of all entries of the secondary calendar for that date. In another example, selecting icon 420 may expand all entries of the secondary calendar for all dates. Although not shown in FIG. 4, an awareness indicator may be used to display calendar entries in the agenda format.

Display of an icon corresponding to an event of a secondary calendar may be toggled on or off by a user. Similarly, display of an awareness indicator may be toggled on or off by a user. User selection may change the calendar user interface 400 among the agenda view and the day view (e.g., shown in FIGS. 1A, 1B, 2, and 3) or to other views, such as a 3 day, week, month, or year view. Blocked off calendar entries may appear in an agenda view (or any other view).

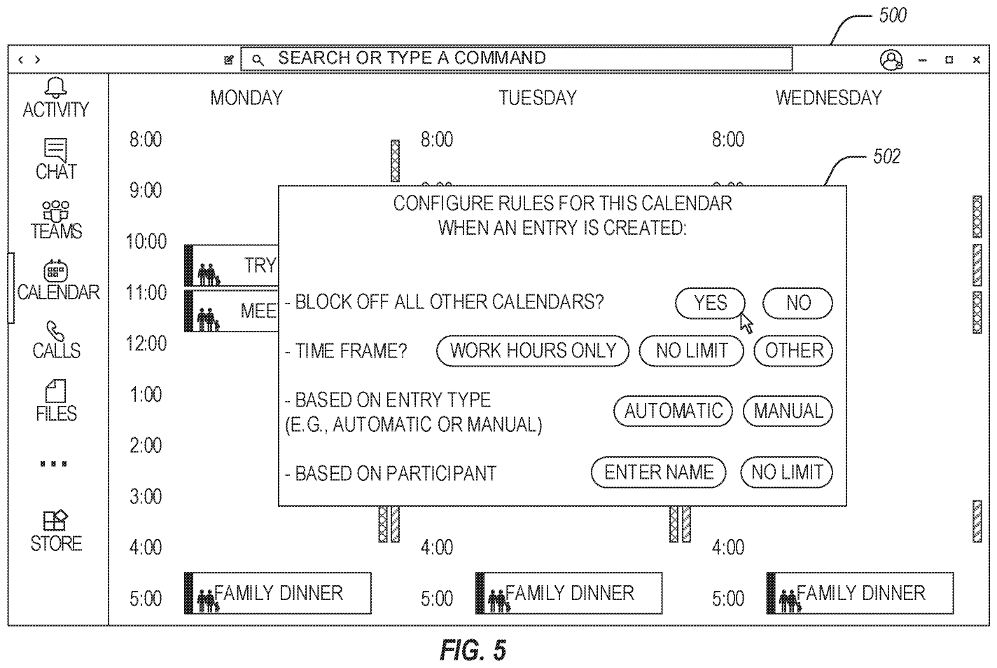

FIG. 5 illustrates an example calendar user interface 500 for configuring a rule according to some examples of the present disclosure. The calendar user interface 500 is an example user interface that may be used for example on a larger screen than a cell phone, such as a tablet, a monitor of a desktop or laptop computer, a television, a video conferencing screen, or the like. The calendar user interface 500 includes may include a context as described herein, such that a current primary calendar is displayed.

The calendar user interface 500 includes a rule configuration component 502 for allowing a user to configure rules. The rules configured on the component 502 may be rules for the primary calendar shown in the calendar user interface 500 (e.g., according to the context), or may be rules for a user-specified calendar (e.g., a particular secondary calendar).

The rule configuration component 502 includes a plurality of options that may be configured for calendar entries that are populated or generated on the current calendar (or selected calendar). The rules may be applied to a set of calendars (e.g., all secondary calendars when a calendar entry is configured on a primary calendar), a pair of calendars (e.g., calendar 1 and calendar 2 may have a specified rule, where a calendar entry configured on calendar 1 applies a rule to calendar 2), or for a single calendar (e.g., for a work calendar, a family calendar, a school calendar, etc.).

The rule configuration component 502 shows example options of rules that may be configured for calendar entries on a calendar. For example, the rule configuration component 502 allows a user to configure a rule to block off all other calendars when an entry is configured on the current calendar, confine blocking off to a particular time frame (e.g., only block off during working hours), based on an entry type (e.g., when the user configures an entry, block off other calendars, but when someone else configures an entry, such as from a meeting invite, then do not block off other calendars), or based on participant (e.g., an invite from the user's boss may be configured to always block off other calendars, while an invite from a coworker may be configured to not automatically block off other calendars). In an example, a rule may include prompting the user after configuring the calendar entry for whether to block off another calendar. Other options for rules may be used with the techniques and systems described herein.

The rule configuration component 502 may be displayed on the calendar user interface 500 in response to a user input, such as generation of a calendar entry for a first time, or the like. A user input may include a long press on a touchscreen, a right click using a mouse, etc. In an example, a user may configure a rule for blocking off time slots on one or more secondary calendars. For example, blocking off may occur only when certain conditions are met, such as a time of day, a type of entry, a user selection to block off the time slot occurs, a particular person is on a meeting invite, or the like. The blocking off may occur when a user selects an option block off the time slot (e.g., by long pressing or right clicking or the like) on the entry on the primary calendar.

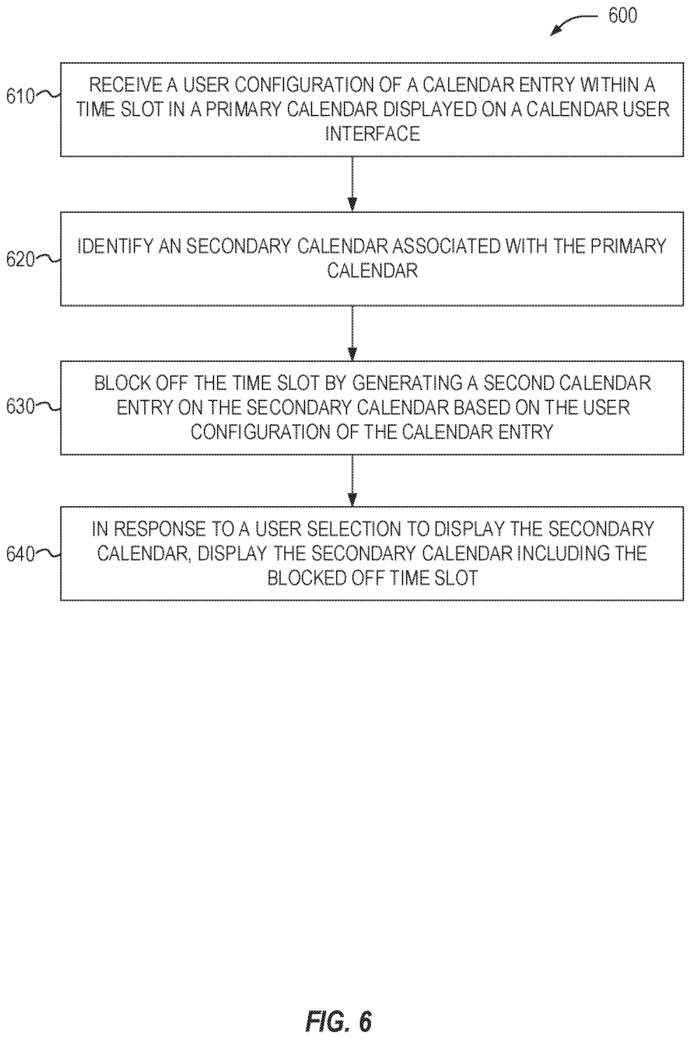

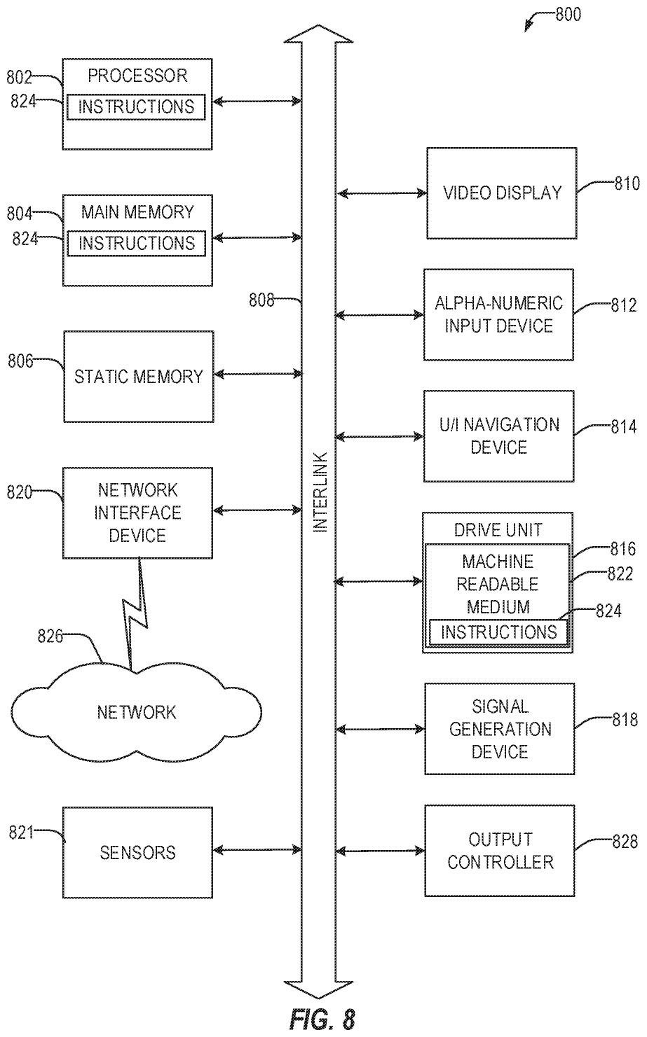

FIG. 6 illustrates a flowchart of a technique for presenting a calendar user interface for user configuration of a calendar entry according to some examples of the present disclosure. The technique 600 may be performed using a processor or processors of a device, such as a computer, a laptop, a mobile device or the like (e.g., as discussed in further detail below with respect to FIG. 8).

The technique 600 includes an operation 610 to receive a user configuration of a calendar entry within a time slot in a primary calendar displayed on a calendar user interface. The technique 600 includes an operation 620 to identify an secondary calendar associated with the primary calendar.

The technique 600 includes an operation 630 to block off the time slot by generating a second calendar entry on the secondary calendar based on the user configuration of the calendar entry. Operation 630 may include generating or displaying the second calendar entry in the secondary calendar without at least one detail of the calendar entry from the primary calendar. The at least one detail may include an attendee, a subject, a location, or the like. In another example, blocking off the time slot may be configured based on a received user input configuring a rule defining an automatic action to be taken with respect to the secondary calendar when the calendar entry is configured in the primary calendar. Operation 630 may include prompting a user to confirm whether to block off the time slot on the secondary calendar.

In an example, the user configuration of the calendar entry includes a generation of the calendar entry. In another example, the user configuration includes a modification to a time characteristic of the calendar entry in the primary calendar (e.g., moving or changing the time or date). In response to the modification, the technique 600 may include automatically modifying the blocked off time slot on the secondary calendar. For example, the second calendar entry may be removed, moved, a new calendar entry may be generated, a color of the second calendar entry may be changed (e.g., greyed out), or the like.

The technique 600 includes an operation 640 to in response to a user selection to display the secondary calendar, display the secondary calendar including the blocked off time slot. In an example, a primary or secondary calendar may be determined based on a user context. For example, a current user context may be used to identify a current primary calendar.

The technique 600 may further include an operation to determine a conflict between the user configuration of the calendar entry in the primary calendar and a third calendar entry on the secondary calendar within the time slot (e.g., when a user tries to configure the third calendar entry to be in the same time slot after the calendar entry is already configured). In response to determining the conflict, an alert may be provided (e.g., a popup indicating the conflict may be displayed to the user, a sound may be played, a communication may be generated or sent, etc.).

In an example, the calendar user interface is operable to display the primary calendar including the calendar entry and at least one awareness indicator of the secondary calendar, the awareness indicator corresponding to a secondary calendar entry of the secondary calendar. In an example, the technique 600 includes an operation to receive a user input on the secondary calendar to generate a third calendar entry in at least a portion of the time slot. The technique 600 may include generating an alert indicating a conflict between the third calendar entry and the calendar entry of the primary calendar.

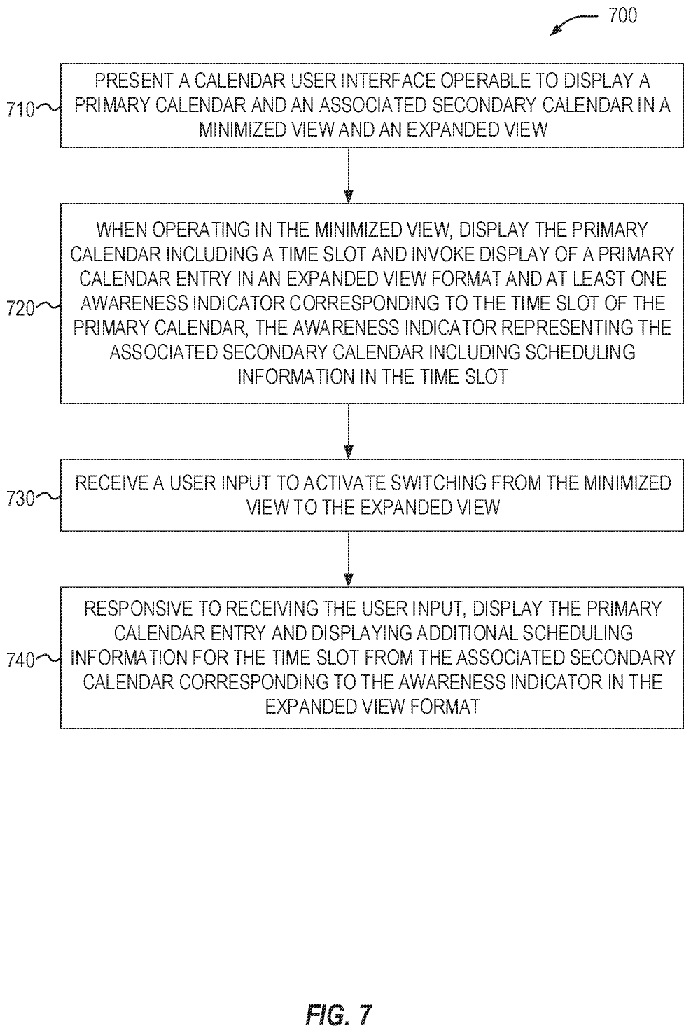

FIG. 7 illustrates a flowchart of a technique 700 for presenting a calendar user interface including a primary calendar and one or more secondary calendars according to some examples of the present disclosure. The technique 700 may be performed using a processor or processors of a device, such as a computer, a laptop, a mobile device or the like (e.g., as discussed in further detail below with respect to FIG. 8).

The technique 700 includes an operation 710 to present a calendar user interface operable to display a primary calendar and an associated secondary calendar in a minimized view and an expanded view. The primary calendar may be identified based on a current user context.

The technique 700 includes an operation 720 to, when operating in the minimized view, display the primary calendar including a time slot and invoke display of a primary calendar entry in an expanded view format and at least one awareness indicator corresponding to the time slot of the primary calendar. In an example, the awareness indicator may represent the associated secondary calendar including scheduling information in the time slot. More than one awareness indicator may be displayed on the calendar user interface, such as two or more awareness indicators corresponding to a first secondary calendar, or one or more awareness indicators corresponding to a first secondary calendar and one or more awareness indicators corresponding to a second secondary calendar. An awareness indicator may be displayed in a reserved portion on a side of the calendar user interface (e.g., in a rightmost 5% or 10% of the calendar user interface).

The technique 700 includes an operation 730 to receive a user input to activate switching from the minimized view to the expanded view. The user input may be a gesture, such as a swipe, a mouse click, a keyboard press, etc.

The technique 700 includes an operation 740 to responsive to receiving the user input, display the primary calendar entry and displaying additional scheduling information for the time slot from the associated secondary calendar corresponding to the awareness indicator in the expanded view format. Operation 740 may include displaying an icon corresponding to the primary calendar at the primary calendar entry or a second icon corresponding to the secondary calendar at the displayed additional scheduling information in the expanded view format. In an example, entries for the primary calendar are displayed in a first color and the awareness indicator or the displayed additional scheduling information in the expanded view format may be displayed in one or more second colors. For example, a calendar's entries or awareness indicators may share a color, but may, for example, have different shades of that color.

The technique 700 may further include an operation to locally cache information related to the additional scheduling information for the time slot from the associated secondary calendar. In response to the user input, the information may be retrieved from the local cache to display on the primary calendar.

In an example, the calendar user interface is operable to display the primary calendar entry in an agenda view that skips dates without entries. The agenda view may include a date corresponding to the awareness indicator, the date not including any calendar entries of the primary calendar.

FIG. 8 illustrates a block diagram of an example machine 800 which may implement one or more of the techniques (e.g., methodologies) discussed herein according to some examples of the present disclosure. In alternative embodiments, the machine 800 may operate as a standalone device or may be connected (e.g., networked) to other machines. In a networked deployment, the machine 800 may operate in the capacity of a server machine, a client machine, or both in server-client network environments. The machine 800 may be configured to perform the methods of FIG. 6. The machine 800 may be configured to provide the GUIs of FIGS. 1A-1D, 2-3, 4A-4B, or 5. In an example, the machine 800 may act as a peer machine in peer-to-peer (P2P) (or other distributed) network environment. The machine 800 may be a user device, a remote device, a second remote device or other device which may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (hereinafter “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may be non-transitory machine-readable media. In some examples, machine readable media may include machine readable media that is not a transitory propagating signal.

The instructions 824 may further be transmitted or received over a communications network 826 using a transmission medium via the network interface device 820. The machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

Example 1 is a method performed by a data processing system for selectively synchronizing data between calendars, the method comprising: receiving a user configuration of a calendar entry within a time slot in a primary calendar; identifying a secondary calendar associated with the primary calendar; blocking off the time slot in the secondary calendar, based on a rule affecting fewer than all entries on the primary calendar, by generating a second calendar entry on the secondary calendar based on the user configuration of the calendar entry; and in response to a user selection to display the secondary calendar, displaying the secondary calendar including the blocked off time slot.

In Example 2, the subject matter of Example 1 includes, wherein blocking off the time slot includes generating and displaying the second calendar entry in the secondary calendar without at least one detail of the calendar entry from the primary calendar.

In Example 3, the subject matter of Example 2 includes, wherein the at least one detail includes at least one of an attendee, a subject, or a location of the calendar entry in the primary calendar.

In Example 4, the subject matter of Examples 1-3 includes, wherein blocking off the time slot is configured based on a received user input configuring the rule defining an automatic action to be taken with respect to the secondary calendar when the calendar entry is configured in the primary calendar.

In Example 5, the subject flatter of Example 4 includes, wherein blocking off the time slot includes prompting a user to confirm whether to block off the time slot on the secondary calendar.

In Example 6, the subject matter of Examples 1-5 includes, determining a conflict between the user configuration of the calendar entry in the primary calendar and a third calendar entry on the secondary calendar within the time slot, and in response, providing an alert.

In Example 7, the subject matter of Examples 1-6 includes, wherein the user configuration of the calendar entry includes a modification to a time characteristic of the calendar entry in the primary calendar, and further comprising, in response to the modification, automatically modifying the blocked off time slot on the secondary calendar.

In Example 8, the subject matter of Examples 1-7 includes, determining the primary calendar based on a current user context.

In Example 9, the subject matter of Examples 1-8 includes, wherein the calendar user interface is operable to display the primary calendar including the calendar entry and at least one awareness indicator of the secondary calendar, the awareness indicator corresponding to a secondary calendar entry of the secondary calendar.

In Example 10, the subject matter of Examples 1-9 includes, receiving a user input on the secondary calendar to generate a third calendar entry in at least a portion of the time slot, and generating an alert indicating a conflict between the third calendar entry and the calendar entry of the primary calendar.

Example 11 is a data processing system for selectively synchronizing data between calendars, the method comprising: a processor and memory, including instructions, which when executed by the processor, cause the processor to perform operations to: receive a user configuration of a calendar entry within a time slot in a primary calendar; identify a secondary calendar associated with the primary calendar; block off the time slot in the secondary calendar, based on a rule affecting fewer than all entries on the primary calendar, by generating a second calendar entry on the secondary calendar based on the user configuration of the calendar entry; and in response to a user selection to display the secondary calendar, display the secondary calendar including the blocked off time slot.

In Example 12, the subject matter of Example 11 includes, wherein the instructions to block off the time slot cause the processor to generate and display the second calendar entry in the secondary calendar without at least one detail of the calendar entry from the primary calendar.

In Example 13, the subject matter of Example 12 includes, wherein the at least one detail includes at least one of an attendee, a subject, or a location of the calendar entry in the primary calendar.

In Example 14, the subject matter of Examples 11-13 includes, wherein blocking off the time slot is configured based on a received user input configuring the rule defining an automatic action to be taken with respect to the secondary calendar when the calendar entry is configured in the primary calendar.

In Example 15, the subject matter of Example 14 includes, wherein the instructions to block off the time slot cause the processor to prompt a user to confirm whether to block off the time slot on the secondary calendar.

In Example 16, the subject matter of Examples 11-15 includes, instructions to cause the processor to determine a conflict between the user configuration of the calendar entry in the primary calendar and a third calendar entry on the secondary calendar within the time slot, and in response, providing an alert.

In Example 17, the subject matter of Examples 11-16 includes, wherein the user configuration of the calendar entry includes a modification to a time characteristic of the calendar entry in the primary calendar, and further comprising, in response to the modification, automatically modifying the blocked off time slot on the secondary calendar.

In Example 18, the subject matter of Examples 11-17 includes, instructions to cause the processor to determine the primary calendar based on a current user context.

In Example 19, the subject matter of Examples 11-18 includes, wherein the calendar user interface is operable to display the primary calendar including the calendar entry and at least one awareness indicator of the secondary calendar, the awareness indicator corresponding to a secondary calendar entry of the secondary calendar.

In Example 20, the subject matter of Examples 11-19 includes, instructions to cause the processor to receive a user input on the secondary calendar to generate a third calendar entry in at least a portion of the time slot, and generating an alert indicating a conflict between the third calendar entry and the calendar entry of the primary calendar.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method performed by a data processing system for selectively synchronizing data between calendars, the method comprising:
receiving a user configuration of a calendar entry within a time slot in a primary calendar;
identifying a secondary calendar associated with the primary calendar;
blocking off the time slot in the secondary calendar, based on a rule affecting fewer than all entries on the primary calendar, by generating a second calendar entry on the secondary calendar based on the user configuration of the calendar entry; and
in response to a user selection to display the secondary calendar, displaying the secondary calendar including the blocked off time slot.

2. The method of claim 1, wherein blocking off the time slot includes generating and displaying the second calendar entry in the secondary calendar without at least one detail of the calendar entry from the primary calendar.

3. The method of claim 2, wherein the at least one detail includes at least one of an attendee, a subject, or a location of the calendar entry in the primary calendar.

4. The method of claim 1, wherein blocking off the time slot is configured based on a received user input configuring the rule defining an automatic action to be taken with respect to the secondary calendar when the calendar entry is configured in the primary calendar.

5. The method of claim 4, wherein blocking off the time slot includes prompting a user to confirm whether to block off the time slot on the secondary calendar.

6. The method of claim 1, further comprising determining a conflict between the user configuration of the calendar entry in the primary calendar and a third calendar entry on the secondary calendar within the time slot, and in response, providing an alert.

7. The method of claim 1, wherein the user configuration of the calendar entry includes a modification to a time characteristic of the calendar entry in the primary calendar, and further comprising, in response to the modification, automatically modifying the blocked off time slot on the secondary calendar.

8. The method of claim 1, further comprising determining the primary calendar based on a current riser context.

9. The method of claim 1, wherein the calendar user interface is operable to display the primary calendar including the calendar entry and at least one awareness indicator of the secondary calendar, the awareness indicator corresponding to a secondary calendar entry of the secondary calendar.

10. The method of claim 1, further comprising receiving a user input on the secondary calendar to generate a third calendar entry in at least a portion of the time slot, and generating an alert indicating a conflict between the third calendar entry and the calendar entry of the primary calendar.

11. A data processing system for selectively synchronizing data between calendars, the method comprising:
a processor and memory, including instructions, which when executed by the processor, cause the processor to perform operations to:
receive a user configuration of a calendar entry within a time slot in a primary calendar;
identify a secondary calendar associated with the primary calendar;
block off the time slot in the secondary calendar, based on a rule affecting fewer than all entries on the primary calendar, by generating a second calendar entry on the secondary calendar based on the user configuration of the calendar entry; and
in response to a user selection to display the secondary calendar, display the secondary calendar including the blocked off time slot.

12. The system of claim 11, wherein the instructions to block off the time slot cause the processor to generate and display the second calendar entry in the secondary calendar without at least one detail of the calendar entry from the primary calendar.

13. The system of claim 12, wherein the at least one detail includes at least one of an attendee, a subject, or a location of the calendar entry in the primary calendar.

14. The system of claim 11, wherein blocking off the time slot is configured based on a received user input configuring the rule defining an automatic action to be taken with respect to the secondary calendar when the calendar entry is configured in the primary calendar.

15. The system of claim 14, wherein the instructions to block off the time slot cause the processor to prompt a user to confirm whether to block off the time slot on the secondary calendar.

16. The system of claim 11, further comprising instructions to cause the processor to determine a conflict between the user configuration of the calendar entry in the primary calendar and a third calendar entry on the secondary calendar within the time slot, and in response, providing an alert.

17. The system of claim 11, wherein the user configuration of the calendar entry includes a modification to a time characteristic of the calendar entry in the primary calendar, and further comprising, in response to the modification, automatically modifying the blocked off time slot on the secondary calendar.

18. The system of claim 11, further comprising instructions to cause the processor to determine the primary calendar based on a current user context.

19. The system of claim 11, wherein the calendar user interface is operable to display the primary calendar including the calendar entry and at least one awareness indicator of the secondary calendar, the awareness indicator corresponding to a secondary calendar entry of the secondary calendar.

20. The system of claim 11, further comprising instructions to cause the processor to receive a user input on the secondary calendar to generate a third calendar entry in at least a portion of the time slot, and generating an alert indicating a conflict between the third calendar entry and the calendar entry of the primary calendar.
